(19) United States
(12) Patent Application Publication
(10) Pub. No.: US 2023/0378461 A1
(43) Pub. Date: Nov. 23, 2023

(54) COATING PROCESS FOR CATHODE MATERIALS FOR RECHARGEABLE BATTERIES

(71) Applicant: Rivian IP Holdings, LLC, Irvine, CA (US)

(72) Inventors: Soo Kim, Fremont, CA (US); Majid Talebiesfandarani, Emeryville, CA (US); Ki Tae Park, Santa Clara, CA (US); Tae Kyoung Kim, Albany, CA (US)

(21) Appl. No.: 17/751,114

(22) Filed: May 23, 2022

(51) Int. Cl. H01M 4/58; H01M 4/04; H01M 10/0525; H01M 4/525; H01M 4/485

(52) U.S. Cl. CPC H01M 4/5825; H01M 4/0404; H01M 10/0525; H01M 4/525; H01M 4/485; H01M 4/0471

(57) ABSTRACT

A process for coating a cathode active material includes dissolving a metal salt in water to generate an aqueous acidic solution; mixing the aqueous acidic solution with the cathode active material for an aging time period to form an acid treated cathode active material; and annealing the acid treated cathode active material at a temperature sufficient to form a lithium metal oxide coating on the cathode active material; wherein: the cathode active material is a high-nickel content lithium cathode active material; the metal salt is M(NO₃)ₓ, MClₓ, MIₓ, M(ClO₃)ₓ, or , M(ClO₄)ₓ; M is Al, Co, Cu, Fe, Mn, Mo, Nb, Ni, Sb, Sc, Sn, Ti, Y, Zr, or a mixture of any two or more thereof; and 1≤x≤8.

### INTRODUCTION

The present technology is generally related to lithium rechargeable batteries. More particularly the technology relates to the process for preparing coatings on cathode active material materials for lithium ion batteries (LIBs).

It has now been found that once a cathode active material is produced, coating precursor for a lithium metal oxide (Li—M—O) coating may be introduced to the cathode active material in a one-pot synthesis, where a cathode active material, coated with lithium metal oxide precursor material may be recovered for further sintering to form the Li—M—O coated cathode active material. The coatings are ionically conductive while being electronically insulating, and protect the underlying cathode active material from reaction with more conventional coating materials or electrolyte degradation products.

### SUMMARY

In one aspect, a process is provided for coating an electrode active material, the process comprising: dissolving a metal salt in a solvent comprising water to generate an aqueous acidic solution; mixing the aqueous acidic solution with the electrode active material for an aging time period to form an acid treated electrode active material; and annealing the acid treated electrode active material at a temperature sufficient to form a lithium metal oxide coating on the electrode active material; wherein: the metal salt is M(NO₃)ₓ, MClₓ, MIₓ, M(ClO₃)ₓ, or, M(ClO₄)ₓ; M is Al, Co, Cu, Fe, Mn, Mo, Nb, Ni, Sb, Sc, Sn, Ti, Y, Zr, or a mixture of any two or more thereof; and 1≤x≤8. In some embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof In other embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof. In some embodiments, the electrode active material is a cathode active material.

In another aspect, a process of manufacturing an electrode for a lithium ion battery includes mixing a lithium metal oxide coated electrode active material with conductive carbon and a binder in a solvent to form a slurry; coating the slurry onto an electrode current collector, and removing the solvent; wherein: the electrode active material has been washed with a metal salt solution; the metal salt is M(NO₃)ₓ, MClₓ, MIₓ, M(ClO₃)ₓ, or, M(ClO₄)ₓ; M is Al, Co, Cu, Fe, Mn, Mo, Nb, Ni, Sb, Sc, Sn, Ti, Y, Zr, or a mixture of any two or more thereof; and 1≤x≤8, followed by secondary heat treatment. In some embodiments, the electrode is a cathode.

In another aspect, a lithium battery includes a cathode comprising a cathode active material; an anode comprising lithium metal; a separator disposed between the cathode and anode; and an electrolyte; wherein: the cathode active material is a high-nickel content lithium cathode active material that has been washed with an aqueous solution of a metal salt solution; the metal salt is M(NO₃)ₓ, MClₓ, MIₓ, M(ClO₃)ₓ, or, M(ClO₄)ₓ; M is Al, Co, Cu, Fe, Mn, Mo, Nb, Ni, Sb, Sc, Sn, Ti, Y, Zr, or a mixture of any two or more thereof; and 1≤x≤8, followed by secondary heat treatment.

In further aspects, an electric vehicle may include any of the lithium batteries, electrochemical cells, or cathode and anode active materials as described herein.

### BRIEF DESCRIPTION OF THE DRAWINGS

FIGS. 1A and 1B are schematic illustrations of a sequential or multi-step washing and coating process flow, where the washing and coating involve a stepwise solution-based approach, following by drying and heat treatment (1A); compared to the “one-pot” synthesis, combined or continuous process of washing and coating using a solution-based acid wash containing metal precursors (1B), according to various embodiments.

FIG. 2 is the calculated reaction profile for the reaction between LiOH and Al(NO₃)₃, where x-axis shows the molar fraction of LiOH (x=0 is 100% LiOH and x=1 is 100% Al(NO₃)₃), they-axis describes the reaction enthalpy in eV/atom, according to the examples.

FIG. 3 is the calculated reaction profile for the reaction between LiOH and AlOOH, according to the examples.

FIG. 4 is a crystallographic depiction of the γ-phase of having LiO₄ and AlO₄ tetrahedral units, known to be the stable phase under ambient conditions.

FIG. 5 is a crystallographic depiction of the α-phase of having LiO₆ and AlO₆ octahedral units, and which is identical to high Ni cathode materials in LIBs.

FIG. 6 is a reproduction of a pressure — temperature phase diagram for the LiAlO₂ α- and γ-phases, calculated by Singh et al. in Phys. Chem. Chem. Phys. 20 (2018) 12248 -12259.

FIG. 7 is a crystallographic depiction of the structure α-LiAlO₂ coating at the top of (101̅4) high Ni cathode surfaces.

FIG. 8 is an illustration of a cross-sectional view of an electric vehicle, according to various embodiments.

FIG. 9 is a depiction of an illustrative battery pack, according to various embodiments.

FIG. 10 is a depiction of an illustrative battery module, according to various embodiments.

FIGS. 11A, 11B, and 11C are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

One of the most common methods to prevent degradation in lithium ion batteries (“LIBs”), is to utilize a protective coating on the electroactive species, particularly with regard to the cathode materials in the batteries. Typically, metal oxide type coatings are used to withstand the harsh operating conditions within the LIBs. Cathode decomposition may occur during the structural phase transition—i.e. where lithium ions (de-)insert from the electrode material - and when in contact with another components of the LIBs, such as the electrolytes and current collectors. Many oxide coatings such as Al₂O₃, MgO, and MnOₓ are commonly used in commercially-available cathode materials with a general formula of Li—M—O, where M is a transition metal. Illustrative commercially available cathode materials include, but are not limited to, LiCoO₂, Li(NiₐMn_{b}Co_{c})O₂ (also referred to a NMC materials), Li(NiₐCo_{b}Al_{c})O₂ (also referred to a NCA materials), Li(Ni_{d}CoₑMn_{f}Al_{g})O₂ (also referred to a NCMA materials), and Li(Mn_{α}Ni_{β})₂O₄, where a+b+c=1, d+e+f+g=1 and α+β=1. Coatings provide at least three major roles in the batteries: 1) formation of the modified solid electrolyte interphase (SEI), which helps stabilize the interface between the electrode and electrolyte, in particular in the event of electrolyte decomposition; 2) improves the electrolyte wetting to ensure uniform Li⁺ ion insertion and de-insertion; and, 3) suppress surface phase transitions of cathode material (i.e., surface decomposition) as a physical barrier.

Li(NiₐMn_{b}Co_{c})O₂ cathode materials (“LiNMC”) need to be activated at high voltage—e.g. above 4 V vs. Li/Li⁺ (i.e., cell formation). At such high voltages, electrolyte decomposition is prevalent, typically starting at about 4.2 V vs. Li/Li⁺. Al₂O₃ has been one of the more studied binary oxide coatings that have been utilized in LIBs. From a cell cycling perspective, it is clearly beneficial to incorporate Al₂O₃ or other binary metal oxide materials as an electrode coating materials. However, it has now been found that when applied to the NMC, the Al₂O₃ consumes Li ions and undergoes a phase transition. For example, when Ni-rich LiNi_{0.8}Mn_{0.1}Co_{0.1}O₂ (NMC811) cathode active material reacts with a Al₂O₃ coating, other phases such as Ni₃O₄, Li₄MnCo₅O₁₂, LiO₈, LiAl₅O₈, and Li₂Mn₃NiO₈, are formed some of which may be redox inactive (i.e., loses capacity), or destructive to the cell.

However, it has also been now found that ternary Li—M—O, when used as coatings for cathode active materials, may prevent, or at least minimize, deleterious side reactions between the coatings the cathode active materials. It has also been found that such coatings are stable against deleterious agents that may be formed in situ in LIBs due to electrolyte, salt, and anode degradation. For example, the coatings described herein can scavenge materials such HF, LiF, PF₅⁻, and LiOH. Accordingly, coatings based upon such Li—M—O materials, methods for their preparation, and methods for their incorporation into LIBs are provided herein.

In the production of high Ni-content NMC cathode materials, lithium salts are added during the synthesis to ensure that a lithium ion is paired with the nickel-manganese-cobalt oxide unit cell. The lithium salts are typically added in excess amounts to ensure complete reaction, where the excess lithium salt is then washed away, typically using water. Removal of the excess lithium is intended to prevent unintended reactions to be converted to Li carbonates at the surface, when exposed to ambient environment (with moisture and oxygen in the air). As the Ni content increases in the NMC cathode materials, LiOH, Li₂CO₃, and LiHCO₃ impurities can be formed more easily (when compared with Co-rich cathode materials). The impurities lead to poor electronic conductivity, decreased ionic diffusivity, increased cell impedance, and decreased rate capabilities. Further, during slurry preparation (i.e. when the cathode active material is mixed with conductive carbon, binders, and/or other materials in a solvent for formation of the cathode), LiOH and LiHCO₃ that may be present in the cathode active material can lead to a higher pH values and gelation of the slurry. Li₂CO₃ present on the surface of the cathode active material can lead to oxidation, releasing CO and CO₂ gas during the first charge cell activations, and causing pressure increases inside the cell. Therefore, the washing process with water is typically conducted during the preparation of NMC materials in general, but specifically in high Ni-content NMC materials, followed by the coating process to coat metal oxides and to remove surface moisture at the cathode.

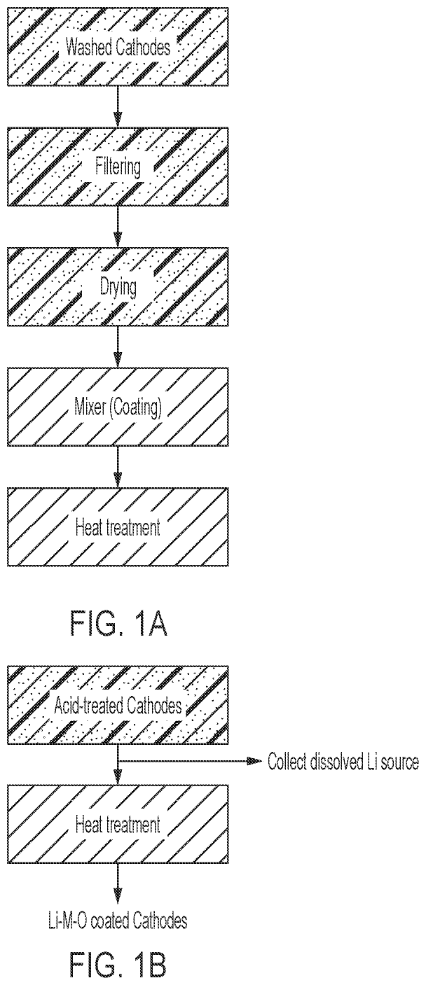

However, with the discovery that the formation of Li—M—O coatings on the surface of cathode active materials may be beneficial, it has now been found that the excess lithium from the formed cathode active material may be used to form the Li—M—O coating. In FIG. 1A, a conventional, multi-step or sequential process of preparing a coated NMC material is illustrated, showing multiple steps including washing the cathode material, isolating it through filtration, drying, mixing with a coating material to form a lithium metal oxide coating, and sintering (i.e. heat treating). The resulting Li—M—O coating may have a thickness on the underlying active material of about 10 nm or less. This includes from about 1 nm to about 10 nm in thickness.

FIG. 1B illustrates schematically the present process that includes a “one-step” or continuous process. The process of FIG. 1B includes dissolving a metal salt in a solvent comprising water to generate an aqueous acidic solution, mixing the aqueous acidic solution with the electrode active material for an aging time period to form an acid treated electrode active material; and annealing the acid treated electrode active material at a temperature sufficient to form a lithium metal oxide coating on the electrode active material. This allows for the deposition of the metal of the lithium metal oxide onto the surface of the electroactive material, and use of excess lithium in the electroactive material to form the coating. The process also allows for recycling and reuse of the acid washings that will also contain dissolved lithium species for reintroduction on the surface of additional electroactive material. In some embodiments, the metal salt is M(NO₃)ₓ, MClₓ, MIₓ, M(ClO₃)ₓ, M(ClO₄)ₓ, or a mixture thereof, where M is Al, Co, Cu, Fe, Mn, Mo, Nb, Ni, Sb, Sc, Sn, Ti, Y, Zr, or a mixture of any two or more thereof; and 1≤x≤8.Here, typically coating materials are binary metal oxides. The H₂O wash solution (from washing the cathode active material) may be collected and recycled to recover dissolved Li salts.

One advantage of this process is that the residual LiOH that may form on the surface of the cathode active material may react with the acidic metal salt solution, thereby forming other lithium salt species that are amenable to inclusion in the Li—M—O coating that is formed. The process takes advantage of the lithium ready present in small amounts that the surface of the cathode active material in forming the thin coating of Li—M—O (i.e. nanometer scale range) on the surface of the cathode active material particles.

In a first aspect, a process for coating a cathode active material includes dissolving a metal salt in water to generate an aqueous acidic solution, mixing the aqueous acidic solution with the cathode active material for an aging time period to form an acid treated cathode active material; and annealing the acid treated cathode active material at a temperature sufficient to form a lithium metal oxide coating on the cathode active material. In the process, the cathode active material is a high-nickel content lithium cathode active material, and the metal salt is M(NO₃)ₓ, MClₓ, MIₓ, M(ClO₃)ₓ, or, M(ClO₄)ₓ, where M is Al, Co, Cu, Fe, Mn, Mo, Nb, Ni, Sb, Sc, Sn, Ti, Y, Zr, or a mixture of any two or more thereof, and 1≤x≤8. The washes from that process may be used as the “water” in the dissolving step for the metal salt, which forms a dilute acidic solution containing dissolve metal salts as metal ions.

In the process, the aging time period is the time period for reaction of the acidic solution with residual lithium and lithium species on the surface of the cathode active material. This time period may vary depending on the metal salt, pH of the metal salt solution, and amount of lithium and lithium species present on the cathode active material. However, generally the aging time is about 24 hours or less. For example, the aging time may be from greater than 0 hours to about 24 hours, from greater than 0 hours to about 24 hours, from about 10 minutes to 24 hours, from about 5 minutes to 2 hours, from about 1 minute to 1 hours, from about 30 seconds to about 30 minutes.

The process may also include, prior to the annealing, collection of the acid treated cathode active material by filtration or other collection methods. The annealing may be carried out a temperature sufficient to form a lithium metal oxide coating on the cathode active material. Illustrative temperatures include 200° C. or greater. For example, the annealing may be conducted from about 200° C. to about 1,000° C., from about 300° C. to about 1,000° C., from about 300° C. to about 900° C., from about 300° C. to about 800° C., or from about 400° C. to about 700° C.

It may be desirable in some instances to conduct one or more of the dissolving, mixing, annealing, filtering, etc. under an inert atmosphere or in an atmosphere that includes oxygen or other gases. Accordingly, the process may include conducting one or more of the dissolving, mixing, filtering, and annealing under an atmosphere of one or more of N₂O₂, Air, Ar, H₂, CO, and CO₂.

The metal salt to be used is one that contains the intended metal of interest for the Li—M—O. Accordingly, the metal salt, in some embodiments, may be a salt of Al, co, cu, Fe, Mn, Mo, Nb, Ni, Sb, Sc, Sn, Ti, Y, Zr, or a mixture of any two or more thereof. Illustrative metal salts include but are not limited to, Al(NO₃)₃, AlCl₃, Al(ClO₄)₃, Al₂(SO₄)₃, Co(NO₃)₂, CoCl₂, Co(ClO₄)₂, CoSO₄, Cu(NO₃)₂, CuCl₂, Cu(ClO₄)₂, CuSO₄, Fe(NO₃)₃, FeCl₂, FeCl₃, FeSO₄, Fe₂(SO₄)₃, Fe(ClO₄)₂, Fe(ClO₄)₃, Mn(NO₃)₂, MnCl₂, Mn(ClO₄)₂, MnSO₄, MoCl₂, MoCl₄, MoCl₅, MoOCl₄, NbCl₄, NbCl₅, Nb(SO₄)₂, Ni(NO₃)₂, NiCl₂, Ni(ClO₄)₂, NiSO₄, SbCl₃, SbCl₅, Sb₂(SO₄)₃, Sb(OCH₃)₃, Sc(NO₃)₃, ScCl₃, Sc(ClO₄)₃, Sn(NO₃)₄, SnCl₂, SnCl₄, SnSO₄, Ti(NO₃)₄, TiCl₄, Ti(ClO₄)₄, Ti(SO₄)₂, TiOSO₄, Y(NO₃)₃, YCl₃, Y(ClO₄)₃, YClO, Y₂(SO₄)₃, Zr(NO₃)₄, ZrCl₄, Zr(ClO₄)₄, Zr(SO₄)₂, or a mixture of any two or more thereof.

By adjusting the stoichiometric ratios appropriately, the stoichiometric ratios of the desired Li—M—O may be obtained. Illustrative lithium metal oxides include, but are not limited to, Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof. In some embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof. In other embodiments, the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

As noted above, the cathode active material is typically a high-nickel content lithium cathode active material. For example, the cathode active material may be a high-nickel content Li(NiₐMn_{b}Co_{c})O₂ (also referred to a NMC materials), Li(NiₐCo_{b}Al_{c})O₂ (also referred to a NCA materials), and Li(Ni_{d}CoₑMn_{f}Al_{g})O₂ (also referred to a NCMA materials) cathode materials, where the nickel is present at 80 wt % or greater. Illustrative cathode active materials may include, but are not limited to, Li(NiₐMn_{b}Co_{c})O₂, LiCoO₂, and Li(Mn_{α}Ni_{β})₂O₄, wherein 0≤a≤1, 0≤b≤1, 0≤c≤1; a+b+c=1a+b+c=1; and α+β=1. In some embodiments, the cathode active material is Li(NiₐMn_{b}Co_{c})O₂, wherein 0<a<1, 0<b<1, 0<c<1, and a+b+c=1. In other embodiments, the cathode active material is LiCoO₂, Li(NiₐMn_{b}Co_{c})O₂, or Li(Mn_{α}Ni_{β})₂O₄, wherein a+b+c=1, and a+0=1. In yet other embodiments, the cathode active material is LiCoO₂, Li(NiₐMn_{b}Co_{c})O₂, or Li(Mn_{α}Ni_{β})₂O₄, wherein 0<a<1, 0<b<1, 0<c<1, a+b+c=1, 0<α<1, 0<β<1, and a+β=1.

The Li—M—O coated cathode active material may then be incorporated into a cathode for a lithium ion battery. This will include suspending the active material with one or more conductive carbon, binders, and other additives in a solvent to form a slurry, coating the slurry on a cathode current collector, and then driving off the solvent to leave a coated current collector as the cathode. Accordingly, in another aspect, a process of manufacturing a cathode for a lithium ion battery includes mixing a lithium metal oxide coated cathode active material with conductive carbon and a binder in a solvent to form a slurry; coating the slurry onto a cathode current collector, and removing the solvent. In this process, the cathode active material is a high-nickel content lithium cathode active material that has been washed with an aqueous solution of a metal salt solution; the metal salt is M(NO₃)ₓ, MClₓ, MIₓ, M(ClO₃)ₓ, or, M(ClO₄)ₓ where M is Al, Co, Cu, Fe, Mn, Mo, Nb, Ni, Sb, Sc, Sn, Ti, Y, Zr, or a mixture of any two or more thereof, and where 1≤x≤8.

Illustrative conductive carbon species include graphite, carbon black, carbon nanotubes, Super P carbon black material, Ketjen Black, acetylene black, single walled carbon nanotubes, multiwalled carbon nanotubes, carbon nanofiber, graphene, graphite, and the like. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA) , poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

The solvent used in the slurry formation may be a ketone, an ether, a heterocyclic ketone, and the like. One illustrative solvent is N-methylpyrrolidone (“NMP”). The solvent may be removed by allowing the solvent to evaporate at ambient or elevated temperature, or at ambient pressure or reduced pressure. Handling of the cathode and other lithium ion battery internal components may be conducted under an inert atmosphere (N₂, He, Ag, etc.), according to some embodiments.

The cathode current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil, and the like.

The cathode active material may be loaded onto the cathode current collector such that after solvent removal coverage is from about 5 mg/cm² to about 50 mg/cm², and the packing density may vary from about 1.0 g/cc to about 5.0 g/cc.

In another aspect, a lithium ion battery is provided that includes the cathodes as described herein. For example, a lithium battery may include a cathode comprising a lithium metal oxide coated cathode active material, conductive carbon, and a binder, an anode, a separator disposed between the cathode and anode, and an electrolyte, where the cathode active material is a high-nickel content lithium cathode active material that has been washed with an aqueous solution of a metal salt solution and annealed to form a lithium metal oxide coating on the surface of the cathode active material. The metal salt may be M(NO₃)ₓ, MClₓ, MIₓ, M(ClO₃)ₓ, or, M(ClO₄)ₓ, where M is Al, Co, Cu, Fe, Mn, Mo, Nb, Ni, Sb, Sc, Sn, Ti, Y, Zr, or a mixture of any two or more thereof, and where 1≤x≤8.

In the lithium ion batteries, the anode may include lithium metal, graphite, Si, SiOₓ, Si nanowire, lithiated Si, or a mixture of any two or more thereof. The anodes may be a source of lithium or provide a lattice within which the lithium may be intercalated from the cathode. Additionally, the electrolyte of the lithium batteries may be either a solution phase electrolyte or a solid-state electrolyte.

In some embodiments, the anode may comprise a current collector (e.g., Cu foil) and an in situ-formed anode (e.g., Li metal) on a surface of the current collector facing the separator or solid-state electrolyte such that in an uncharged state. In such embodiments, the assembled cell does not comprise an anode active material.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles.

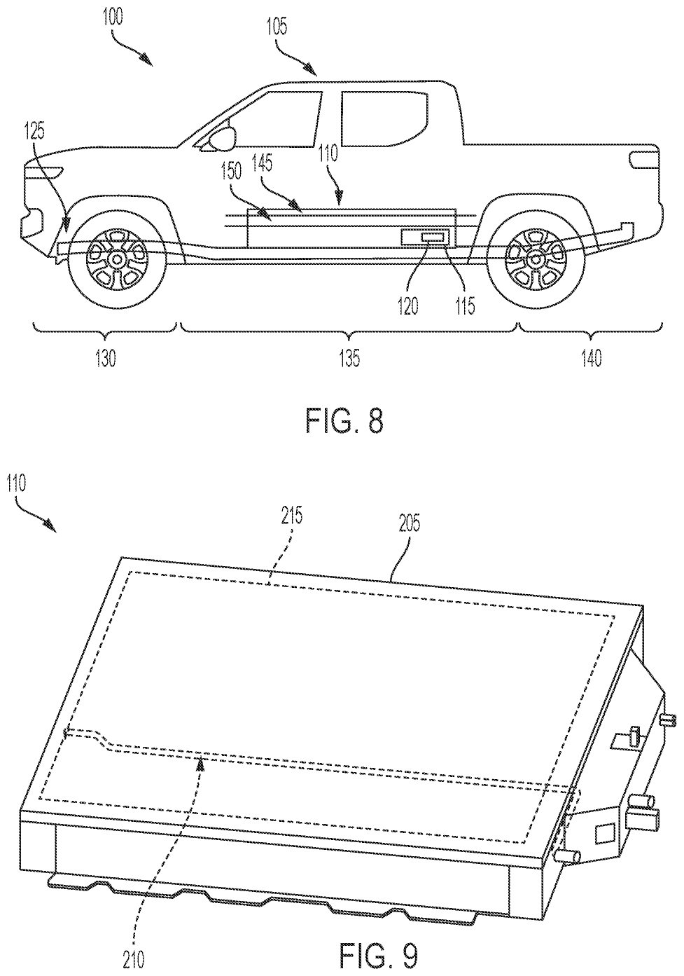

In another aspect, a plurality of battery cells as described above may be used to form a battery and/or a battery pack, that may find a wide variety of applications such as general storage, or in vehicles. By way of illustration of the use of such batteries or battery packs in an electric vehicle, FIG. 8 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

FIG. 9 depicts an example battery pack 110. Referring to FIG. 9, among others, the battery pack 110 can provide power to electric vehicle 105. Battery packs 110 can include any arrangement or network of electrical, electronic, mechanical, or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

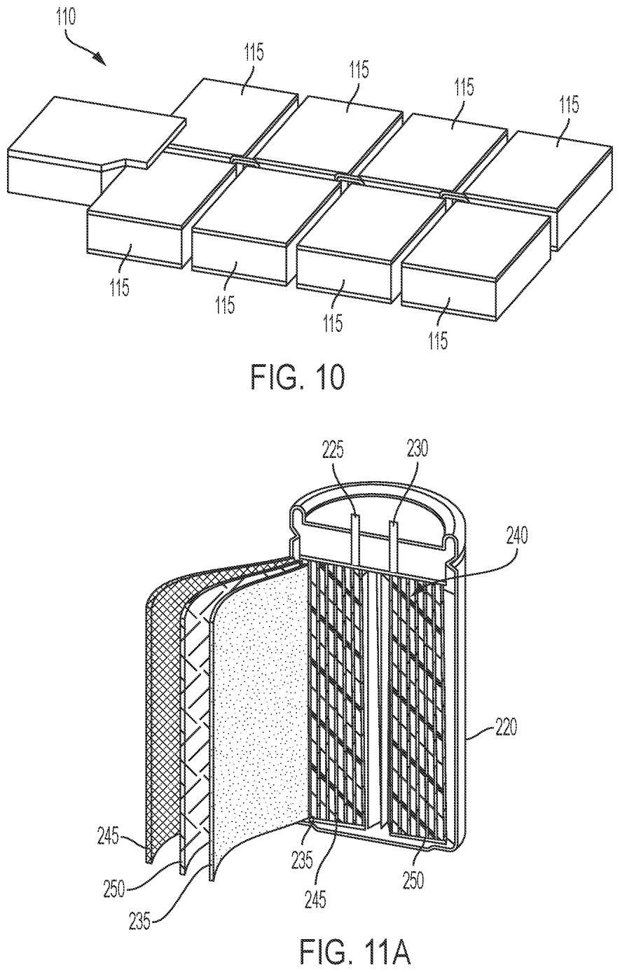

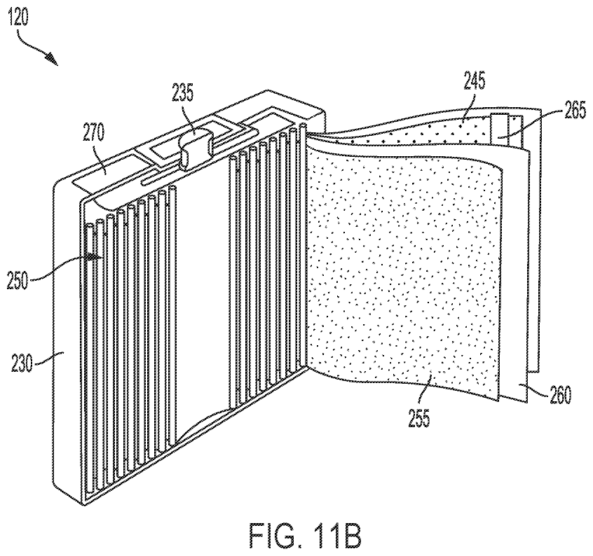

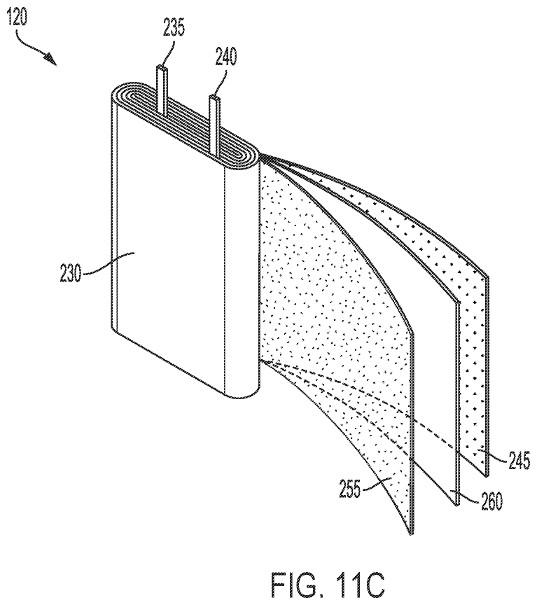

FIG. 10 depicts example battery modules 115, and FIGS. 11A, 11B, and 11C depict illustrative cross sectional views of battery cells 120 in various forms. For example FIG. 11A is a cylindrical cell, 11B is a prismatic cell, and 11C is the cell for use in a pouch. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells, prismatic cells, or pouch cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, or prismatic form factor. Battery cells 120 can be assembled, for example, by inserting a winded or stacked electrode roll (e.g., a jellyroll) including electrolyte material into at least one battery cell housing 230. The electrolyte material, e.g., an ionically conductive fluid or other material, can generate or provide electric power for the battery cell 120. A first portion of the electrolyte material can have a first polarity, and a second portion of the electrolyte material can have a second polarity. The housing 230 can be of various shapes, including cylindrical or rectangular, for example. Electrical connections can be made between the electrolyte material and components of the battery cell 120. For example, electrical connections with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Yet further, some battery cells 120 can be solid state battery cells and other battery cells 120 can include liquid electrolytes for lithium-ion battery cells.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others. The housing 230 can be rigid or not rigid (e.g., flexible).

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 can include at least one anode layer 245, at least one cathode layer 255, and an electrolyte layer 260 disposed within the cavity 250 defined by the housing 230. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated).

FIGS. 11A, 11B, and 11C are illustrative cross-sectional views of various battery cells 120. The battery cell 120 can be or include a prismatic battery cell 120. The prismatic battery cell 120 can have a housing 230 that defines a rigid enclosure (FIG. 11B). The housing 230 can have a polygonal base, such as a triangle, square, rectangle, pentagon, among others. For example, the housing 230 of the prismatic battery cell 120 can define a rectangular box. The prismatic battery cell 120 can include at least one anode layer 245, at least one cathode layer 255, and at least one electrolyte layer 260 disposed within the housing 230. The prismatic battery cell 120 can include a plurality of anode layers 245, cathode layers 255, and electrolyte layers 260. For example, the layers 245, 255, 260 can be stacked or in a form of a flattened spiral. The prismatic battery cell 120 can include an anode tab 265. The anode tab 265 can contact the anode layer 245 and facilitate energy transfer between the prismatic battery cell 120 and an external component. For example, the anode tab 265 can exit the housing 230 or electrically couple with a positive terminal 235 to transfer energy between the prismatic battery cell 120 and an external component.

The prismatic battery cell 120 (FIG. 11B) can also include a pressure vent 270. The pressure vent 270 can be disposed in the housing 230. The pressure vent 270 can provide pressure relief to the prismatic battery cell 120 as pressure increases within the prismatic battery cell 120. For example, gases can build up within the housing 230 of the prismatic battery cell 120. The pressure vent 270 can provide a path for the gases to exit the housing 230 when the pressure within the prismatic battery cell 120 reaches a threshold.

The present invention, thus generally described, will be understood more readily by reference to the following examples, which are provided by way of illustration and are not intended to be limiting of the present invention.

### EXAMPLES

Aluminum nitrate, Al(NO₃)₃, is dissolved in water to provide an acidic solution of Al³⁺ and NO₃⁻ species present. For example, a 2M Al(NO₃)₃ solution exhibits a pH of about 2.6. As the molar concentration decreases, the resulting pH also increases. This would be similar for metal nitrates, chlorides, and other salts, that lead to the formation of strong acids including but not limited to hydrochloric acid (HCl), nitric acid (HNO₃), hydroiodic acid (HI), perchloric acid (HClO₄), or chloric acid (HClO₃). Weak acids include, but are not limited to, sulfurous acid (H₂SO₃), methanoic acid (HCO₂H), phosphoric acid (H₃PO₄), and nitrous acid (HNO₃). While strong acids completely dissociate in water, weak acids do not. Typically, the metal ion of the salt leads to the formation of hydroxide (e.g., Al(NO₃)₃ may form Al(OH)₃), where Al(OH)₃ is a weak base and HNO₃ is a strong acid. Therefore, a solution containing a metal salt with a general chemical formula, M(NO₃)ₓ, MClₓ, MIₓ, M(ClO₃)ₓ, or, M(ClO₄)ₓ, where x can vary from 1 to 8 depending on the metal oxidation state, is likely to form a “weak” acid when dissolved in H₂O, whereas a “strong” acid portion wins out the “weak” base portion from the metal ions. Other metal salts of other anions can be used in this process; however, the pH values may be higher and/or take longer time for the complete ionization in H₂O.

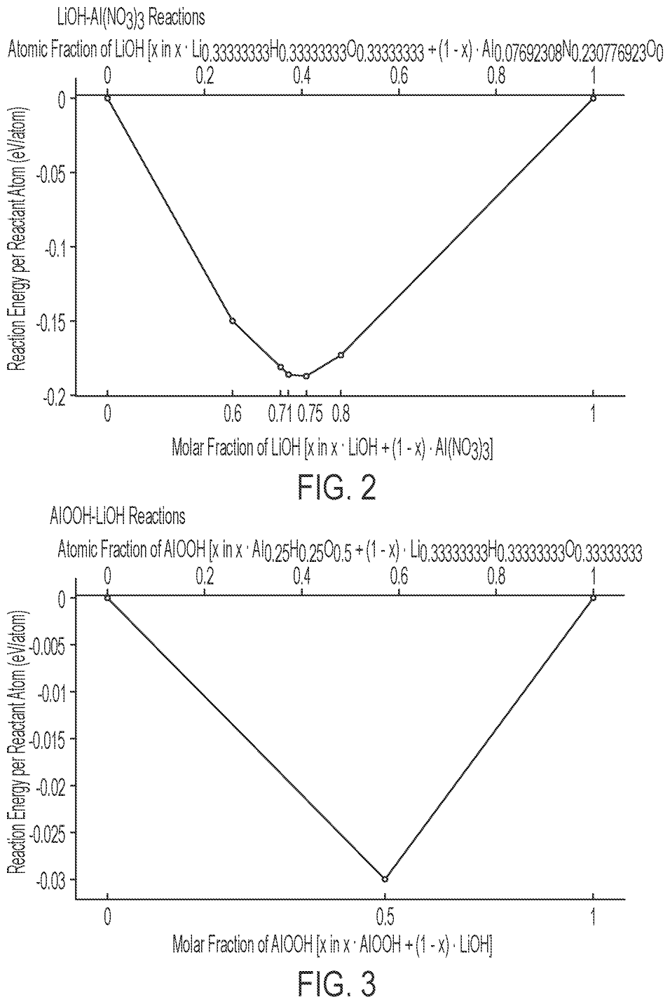

First-principles density functional theory (DFT) methodologies were used to understand the reaction between Li surface salt (such as LiOH) and acidic metal solution (e.g., Al(NO₃)₃, dissolved in H₂O). The interface app in materialproject.org was used as the predictive software for the calculations. FIG. 2 shows the chemical reaction between LiOH and Al(NO₃)₃. The x-axis shows the molar fraction x=0 to x=1 and the y-axis shows the reaction energy (eV) per atom (Eᵣₓₙ). FIG. 2 shows that when x=0.75, 0.75 LiOH reacts with 0.25 Al(NO₃)₃ to form 0.25 AlOOH, 0.75 LiNO₃, and 0.25 H₂O with an enthalpy of reaction (Eᵣₓₙ) of −0.187 eV/atom. Among these reaction products, LiNO₃ is soluble in H₂O, while the solubility of AlOOH in water is low, and therefore it would remain at the cathode surface with un-washed, excess LiOH.

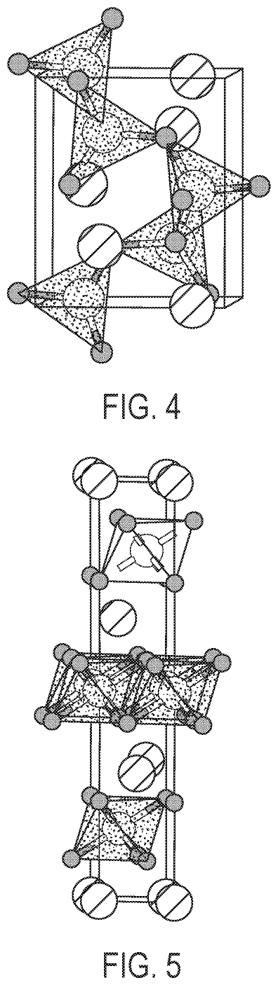

FIG. 3 shows the chemical reaction between AlOOH and LiOH. It shows that 0.5LiOH reacts with 0.5AlOOH to yield 0.5LiAlO₂ and 0.5H₂O with the Eᵣₓₙ of −0.030 eV/atom. LiAlO₂ has several polymorphs, where the γ-phase is known to be a stable phase under ambient conditions and having LiO₄ and AlO₄ tetrahedral units (FIG. 4). Also, there is also an α-LiAlO₂ phase, as shown in FIG. 5, having LiO₆ and AlO₆ octahedra in hexagonal symmetry. The α-phase may be experimentally obtained at high temperature and/or pressure range (i.e., 0.5 to 3.5 GPa, 933-1123 K). It is noteworthy that the α-LiAlO₂ phase exhibits an identical crystal symmetry with high Ni cathode materials used in LIBs.

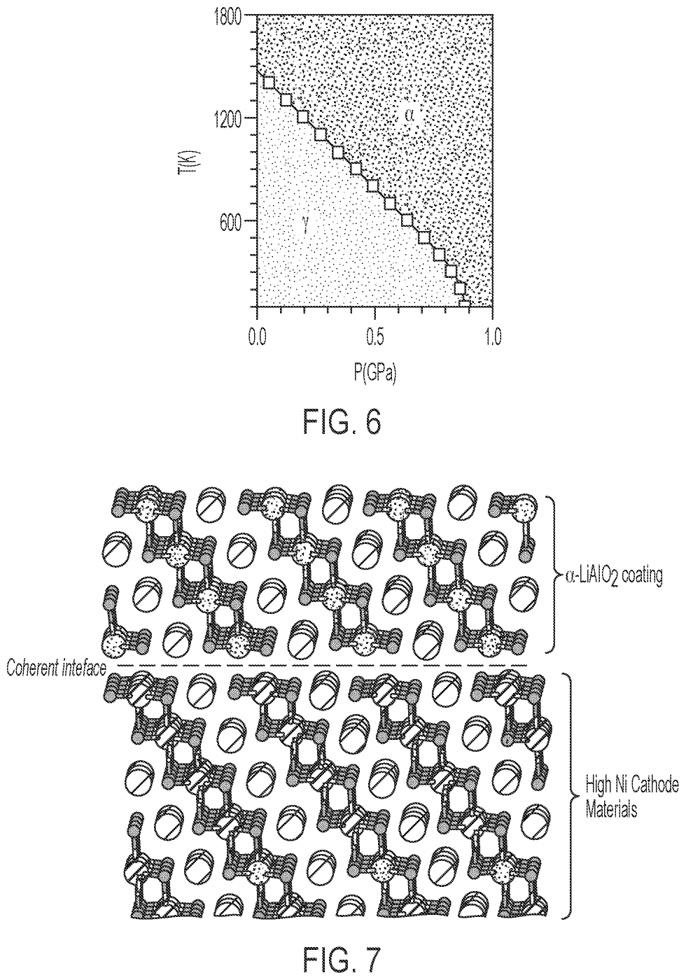

As mentioned above, phase transitions between the α-phase and γ-phase can take place in different temperature conditions and/or zero to high-pressure conditions. FIG. 6 is a pressure—temperature phase diagram for the α- and γ-phases, as calculated and that may be controlled by the heat treatment process temperature and conditions. Another factor may include the interfacial stability between the coating and the cathode materials. Although the γ-phase of LiAlO₂ may be more stable in the ambient conditions, since the coating is to grow at the cathode surface as the substrate, it may be easier to grow the α-phase of LiAlO₂ having LiO₆ and AlO₆ octahedron units at the high Ni cathode materials, as demonstrated in FIG. 6.

FIG. 7 is a crystal structure schematic drawing of the most energetically stable (101̅4) surface of LiMO₂ (M=Ni, Co, Mn, Al) layered compound. Because the α-LiAlO₂ phase follows the same crystallographic symmetry, the cathode coating can form a coherent interface at the top of cathode materials, as schematically demonstrated in FIG. 7. The excess LiOH and AlOOH (originated from acidic solution prepared by dissolving Al(NO₃)₃ in H₂O) can react to yield a LiAlO₂ coating materials during the secondary heat treatment as the post-treatment step.

The following Li—M—O compounds have been identified as exhibiting superior, or at least comparable, properties to those of LiAlO₂ coating materials. The identified compounds are Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, and Li₂ZrO₃. The materials are stable at high voltage conditions.

Table 1 presents a listing of metal precursors to Li—M—O coatings. The precursors include those where the metal is Al, Ti, Fe, Ni, Cu, Zr, Nb, Mo, Sn, Y, Sb, Sc, Mn, and/or Co.

TABLE 1
List of metal precursors to yield Li—M—O coatings

| Metal Precursors | Li—M—O |
|---|---|
| Al(NO₃)₃, AlCl₃, Al(ClO₄)₃, Al₂(SO₄)₃, etc. | LiAlO₂, Li₅AlO₄ |
| Ti(NO₃)₄, TiCl₄, Ti(ClO₄)₄, Ti(SO₄)₂, TiOSO₄, etc. | Li₄TiO₄, Li₂TiO₃ |
| Fe(NO₃)₃, FeCl₂, FeCl₃, FeSO₄, Fe₂(SO₄)₃, | Li₅FeO₄, Li₂FeO₃, |
| Fe(ClO₄)₂, Fe(ClO₄)₃, etc. | LiFeO₂ |
| Ni(NO₃)₂, NiCl₂, Ni(ClO₄)₂, NiSO₄, etc. | LiNiO₂, LiNi₂O₄, |
| | Li₂NiO₃ |
| Cu(NO₃)₂, CuCl₂, Cu(ClO₄)₂, CuSO₄, etc. | Li₃CuO₃ |
| Zr(NO₃)₄, ZrCl₄, Zr(ClO₄)₄, Zr(SO₄)₂, etc. | Li₆Zr₂O₇, Li₂ZrO₃ |
| NbCl₄, NbCl₅, Nb(SO₄)₂, etc. | Li₈Nb₂O₉, Li₃NbO₄ |
| MoCl₂, MOCl₄, MoCl₅, MoOCl₄, etc. | Li₄MoO₅, Li₂MoO₄ |
| Sn(NO₃)₄, SnCl₂, SnCl₄, SnSO₄, etc. | Li₂SnO₃, Li₈SnO₆ |
| Y(NO₃)₃, YCl₃, Y(ClO₄)₃, YClO, Y₂(SO₄)₃, etc. | LiYO₂ |
| SbCl₃, SbCl₅, Sb₂(SO₄)₃, Sb(OCH₃)₃, etc. | Li₅SbO₅ |
| Sc(NO₃)₃, ScCl₃, Sc(ClO₄)₃, etc. | LiScO₂ |
| Mn(NO₃)₂, MnCl₂, Mn(ClO₄)₂, MnSO₄, etc. | Li₂MnO₃ |
| Co(NO₃)₂, CoCl₂, Co(ClO₄)₂, CoSO₄, etc. | Li₂CoO₃ |

There are four different types of simulation results presented in Table 2. The very first case, denoted as Type-I, is similar to Al(NO₃)₃, i.e., LiOH reaction leading to an intermediate precursor (e.g., AlOOH) that then further reacts with LiOH to form a Li—M—O precursor (e.g., LiAlO₂). In Table 2, there are three cases belonging to Type-I: i.e., Ti(NO₃)₄ to Li₂TiO₃, Fe(NO₃)₃ to LiFeO₂, and Sn(NO₃)₄ to Li₂SnO₃.

In a Type-II reaction, LiOH first reacts to provide an intermediate precursor, and then a second reaction produces a lithium metal oxide different from a predicted endpoint. Nb(SO₄)₂ to LiNbO₃ and Sb(SO₄)₃ to Li₃SbO₄ belong to this category. In both cases, the reaction produces a Li—M—O compound that would be ionically conductive and/or that can be chemically modified to produce the desired stoichiometric compounds.

The third type (i.e., Type-III) forms an intermediate precursor that is predicted to not react with LiOH. The quantum mechanics calculations at T=0 K predict that these compounds are too stable to react with LiOH. In Table 2, Ni(NO₃)₂, Cu(NO₃)₂, Zr(NO₃)₄, YClO, Sc(NO₃)₃, MnSO₄, and CoSO₄ led to the formation of NiO, CuO, ZrO₂, YOOH, ScOOH, MnO, and CoO that are too stable to form a new Li—M—O compound at T=0 K condition. From experiments, Ni(NO₃)₂, MnSO₄, and/or CoSO₄ that can dissolve in H₂O are commonly used to synthesize M(OH)ₓ and/or MOₓ precursors. The metal hydroxide or metal oxide compounds are then mixed with LiOH and annealed to prepare Li—M—O cathode materials such as high Ni NMC, NCA, or NCMA cathode materials. Based on this, the Type-I and Type-II compounds may require lower heat treatment temperatures than Type-III to yield desired Li—M—O compounds. The Type-III may yield Li—M—O coatings at high temperature heat treatment.

A further category, not shown (i.e., Type-IV) is MoCl₅, immediately forming a desired Li₂MoO₄ compound, but its byproduct MoO₂ is not reactive with LiOH (like Type-III). However, it is believed that the product may be tuned to yield Li₄MoO₅ or Li₂MoO₄ at higher heat treatment temperatures.

TABLE 2
Sample chemical reactions with excess LiOH yield Li—M—O coatings. Some binary oxide materials are too stable
to be converted to Li—M—O candidates at T = 0 K, that may require secondary heat treatment process.
For example, Li₂MnO₃ can be synthesized at 400° C. using Mn precursor with LiOH.

| | | | |
|---|---|---|---|
| | E_{rxn,1} | | E_{rxn,2} |
| 1^{st} reaction step with LiOH | _{[eV/atom]} | 2^{nd} reaction step with LiOH | _{[eV/atom]} |

Type I Reaction

| | | | |
|---|---|---|---|
| 0.8 LiOH + 0.2 Ti(NO₃)₄ → | −0.121 | 0.667 LiOH + 0.333 TiO₂ → 0.333 Li₂TiO₃ + | −0.051 |
| 0.8 LiNO₃ + 0.4 H₂O + 0.2 TiO₂ | | 0.333 H₂O | |
| 0.25 Fe(NO₃)₃ + 0.75 LiOH → | −0.183 | 0.5 LiOH + 0.5 FeHO₂ → | −0.006 |
| 0.25 FeOOH + 0.75 LiNO₃ + 0.25 H₂O | | 0.5 LiFeO₂ + 0.5 H₂O | |
| 0.2 Sn(NO₃)₄ + 0.8 LiHO → | −0.141 | 0.333 SnO₂ + 0.667 LiOH → 0.067 | −0.014 |
| 0.8 LiNO₃ + 0.4 H₂O + 0.2 SnO₂ | | Li₂Sn(H₅O₄)₂ + 0.267 Li₂SnO₃ | |

Type II Reaction

| | | | |
|---|---|---|---|
| 0.785 LiHO + 0.215 Nb(SO₄)₂ → | −0.241 | 0.667 LiHO + 0.333 Nb₂O₅ → 0.667 | −0.064 |
| 0.107 Nb₂O₅ + 0.393 H₂O + 0.393 | | LiNbO₃ + 0.333 H₂O | |
| Li₂SO₄ + 0.005 S₈O | | | |
| 0.143 Sb₂(SO₄)₃ + 0.857 LiHO → 0.143 | −0.177 | 0.783 LiHO + 0.217 Sb₂O₃ → 0.261 | −0.002 |
| Sb₂O₃ + 0.429 Li₂SO₄ + 0.429 H₂O | | Li₃SbO₄ + 0.174 Sb + 0.391 H₂O | |

Type III Reaction

| | | | |
|---|---|---|---|
| 0.667 LiOH + 0.333 Ni(NO₃)₂ → | −0.079 | N/A (i.e., NiO is too at 0 K stable) | N/A |
| 0.667 LiNO₃ + 0.333 NiO + 0.333 H₂O | | | |
| 0.333 Cu(NO₃)₂ + 0.667 LiOH → | −0.107 | N/A (i.e., CuO is too at 0 K stable) | N/A |
| 0.667 LiNO₃ + 0.333 CuO + 0.333 H₂O | | | |
| 0.2 Zr(NO₃)₄ + 0.8 LiOH → | −0.135 | N/A (i.e., ZrO₂ is too at 0 K stable) | N/A |
| 0.8 LiNO₃ + 0.4 H₂O + 0.2 ZrO₂ | | | |
| 0.143 MoCl₅ + 0.857 LiHO → | −0.158 | N/A (i.e., MoO₂ is too stable at 0 K) | N/A |
| 0.071 Li₂MoO₄ + 0.071 MoO₂ + 0.714 | | | |
| LiCl + 0.429 H₂O | | | |
| 0.5 YClO + 0.5 LiHO → 0.5 YOOH + 0.5 | −0.038 | N/A (i.e., YOOH is too stable at 0 K) | N/A |
| LiCl | | | |
| 0.25 Sc(NO₃)₃ +0.75 LiHO → | −0.183 | N/A (i.e., ScOOH is too stable at 0 K) | N/A |
| 0.25 ScOOH + 0.75 LiNO₃ + 0.25 H₂O | | | |
| 0.333 MnSO₄ + 0.667 LiHO → 0.333 | −0.079 | N/A (i.e., MnO is too stable at 0 K) | N/A |
| Li₂SO₄ + 0.333 MnO + 0.333 H₂O | | | |
| 0.667 LiHO + 0.333 CoSO₄ → 0.333 CoO + | −0.115 | N/A (i.e., CoO is too stable at 0 K) | N/A |
| 0.333 Li₂SO₄ + 0.333 H₂O | | | |

### SUMMARY

Although various metal precursors may proceed via different reaction pathways, it is believed (without being bound by theory) that in Table 2 that the “weak” acidic metal solutions can react with excess LiOH to yield an insoluble metal (hydroxide) oxide (e.g., MOₓ, MOOH, etc.). Then, these compounds can further react with remaining LiOH to yield Li—M—O coating at the cathode surfaces. We observe that the Type I and Type II reactions/compounds may be more thermodynamically favorable, and thus not require a very high temperature for the secondary heat treatment. For example, in the case of Li₂TiO₂, LiFeO₂, or Li₂SnO₃ it is expected that low temperature annealing may be less or equal to 400° C. to yield a desirable Li—M—O coating candidate. However, heat treatment temperatures from 400 to 1200° C. and/or gas environment (reducing or oxidizing, using H₂, N₂, Ar, air, and/or O₂) may be helpful in suing the Type-II, -III, or -IV coatings to yield desired Li—M—O coating candidates.

Experimental procedure. A metal-containing precursor chemical including but not limited to metal nitrates, chloride, sulfate, etc. is dissolved in water. Such solutions are typically weakly acidic, containing dissolved metal ions in acidic environment (HNO₃, HCl, H₂SO₄, etc.). The metal solution is then to be mixed with a high nickel content cathode active material (Ni>=80%), after the calcination and cooling step, where the high nickel content cathode active material has excess Li impurities at the surface. The mixing time may vary depending on the pH of the solution, but is typically less than 24 hours until desired pH level is reached. The pH of the solution may be controlled by the presence of acid or base. The metal solution contains a soluble Li salt, i.e. LiNO₃, that can be collected separately, leaving MOₓ and/or MOOH at the surface of cathode materials to further react with LiOH. The mixture of the precursor(s) and as-synthesized high nickel content cathode active materials is to be annealed at elevated temperature. Illustrative temperatures include, any of the following or ranges between any two of the following: 200, 250, 300, 350, 400, 450, 500, 550, 600, 650, 700, 750, 800, 850, 900, 950 and 1,000° C. The aging time (i.e. the contact time between the acid solution and the cathode active material) may be any the following or may range between any two of the following values: 1, 2, 3, 4, 8, 12, 16, 24, 36, 48, 60, and 72 hours. Depending on the choice of coatings, reducing/oxidizing conditions may be used, including, but not limited to an atmosphere of N₂, O₂, Air, Ar, H₂, CO, CO₂, mixture thereof, and the like. The materials may include a thin coating layer at the outer surface in a form of island or conformal coatings. In the case of polycrystalline NMC cathode materials (i.e. those containing nickel, manganese, and cobalt), or NCA, or NCMA, the surface coating may be present near the grain boundaries as nucleation site. In the case of single crystalline cathode materials, layered oxide materials such LiMO₂ (M═Al, Fe, Y, Sc, Ni) and/or Li-excess Li₂MO₃ (Ti, Fe, Zr, Ni, Co, Sn, Mn) may be chosen to reduce the interfacial resistance between two crystal structure (i.e., cathode∥coating interface).

Active materials containing Li—M—O coated high Ni cathodes will be mixed with carbon and binder materials in a suitable solvent, such as NMP, to form a slurry. The slurry will be coated onto an Al foil and then dried in the oven to remove the solvent. The loading level of cathode materials may vary from 5 to 50 mg/cm² and the packing density may vary from 1.0 to 5.0 g/cc. The electrode is to be assembled as the cathode in Li-ion batteries, where the anode materials can be Li metal, graphite, Si, SiOₓ, Si nanowire, lithiated Si, or mixture thereof. A traditional liquid electrolyte may be used (i.e. containing LiPF₆), and including any of a variety of carbonate solvents. In other embodiments, a solid-state electrolyte may be used that includes oxide, sulfide, or phosphate-based crystalline materials as a replacement for liquid electrolytes. The cell configuration may be prismatic, cylindrical, or pouch type. Each cell can further configured together to design pack, module, or stack with desired power output.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A process for coating a cathode active material, the process comprising:
dissolving a metal salt in a solvent comprising water to generate an aqueous acidic solution;
mixing the aqueous acidic solution with the cathode active material for an aging time period to form an acid treated cathode active material; and
annealing the acid treated cathode active material at a temperature sufficient to form a lithium metal oxide coating on the cathode active material;
wherein:
the cathode active material contains 80 wt % or greater of nickel;
the metal salt is M(NO₃)ₓ, MClₓ, MIₓ, M(ClO₃)ₓ, M(ClO₄)ₓ, or a mixture thereof;
M is Al, Co, Cu, Fe, Mn, Mo, Nb, Ni, Sb, Sc, Sn, Ti, Y, Zr, or a mixture of any two or more thereof; and
1≤x≤8.

2. The process of claim 1, wherein the aging time is >0 hours to less than 24 hours.

3. The process of claim 1 further comprising prior to annealing, separating the acid treated cathode active material by filtration from a filtrate.

4. The process of claim 3 further comprising collecting the filtrate and recycling.

5. The process of claim 1, wherein the annealing is conducted at 200° C. or greater.

6. The process of claim 1, wherein one or more of the dissolving, mixing, and annealing are conducted under an atmosphere of one or more of N₂, O₂, Air, Ar, H₂, CO, and CO₂.

7. The process of claim 1, wherein the metal salt is Al(NO₃)₃, AlCl₃, Al(ClO₄)₃, Al₂(SO₄)₃, Co(NO₃)₂, CoCl₂, Co(ClO₄)₂, CoSO₄, Cu(NO₃)₂, CuCl₂, Cu(ClO₄)₂, CuSO₄, Fe(NO₃)₃, FeCl₂, FeCl₃, FeSO₄, Fe₂(SO₄)₃, Fe(ClO₄)₂, Fe(ClO₄)₃, Mn(NO₃)₂, MnCl₂, Mn(ClO₄)₂, MnSO₄, MoCl₂, MoCl₂, MoCl₄, MoCl₅, MoOCl₄, NbCl₄, NbCl₅, Nb(SO₄)₂, Ni(NO₃)₂, NiCl₂, Ni(ClO₄)₂, NiSO₄, SbCl₃, SbCl₅, Sb₂(SO₄)₃, Sb(OCH₃)₃, Sc(NO₃)₃, ScCl₃, Sc(ClO₄)₃, Sn(NO₃)₄, SnCl₂, SnCl₄, SnSO₄, Ti(NO₃)₄, TiCl₄, Ti(ClO₄)₄, Ti(SO₄)₂, TiOSO₄, Y(NO₃)₃, YCl₃, Y(ClO₄)₃, YClO, Y₂(SO₄)₃, Zr(NO₃)₄, ZrCl₄, Zr(ClO₄)₄, Zr(SO₄)₂, or a mixture of any two or more thereof.

8. The process of claim 1, wherein the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

9. The process of claim 1, wherein the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, or a mixture of any two or more thereof.

10. The process of claim 1, wherein the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, or a mixture of any two or more thereof.

11. The process of claim 1, wherein the acid treated cathode active species comprises surface lithium-containing species.

12. The process of claim 1, wherein the surface of the cathode active material comprises lithium-containing species.

13. The process of claim 12, wherein the lithium-containing species comprises LiOH.

14. The process of claim 1, wherein the ternary lithium metal oxide coating has a thickness of 10 nm or less.

15. The process of claim 1, wherein the solvent further comprises an alcohol, ether, ketone, amine, carbonate, or a mixture of any two or more thereof

16. A process of manufacturing an electrode for a lithium ion battery, the process comprising:
mixing a lithium metal oxide coated electrode active material with conductive carbon and a binder in a solvent to form a slurry;
coating the slurry onto an electrode current collector, and removing the solvent to form the electrode;
wherein:
the electrode active material has been washed with a metal salt solution;
the metal salt is M(NO₃)ₓ, MClₓ, MIₓ, M(ClO₃)ₓ, or, M(ClO₄)ₓ;
M is Al, Co, Cu, Fe, Mn, Mo, Nb, Ni, Sb, Sc, Sn, Ti, Y, Zr, or a mixture of any two or more thereof; and
1≤x≤8.

17. The process of claim 16, wherein the metal salt is Al(NO₃)₃, AlCl₃, Al(ClO₄)₃, Al₂(SO₄)₃, Co(NO₃)₂, CoCl₂, Co(ClO₄)₂, CoSO₄, Cu(NO₃)₂, CuCl₂, Cu(ClO₄)₂, CuSO₄, Fe(NO₃)₃, FeCl₂, FeCl₃, FeSO₄, Fe₂(SO₄)₃, Fe(ClO₄)₂, Fe(ClO₄)₃, Mn(NO₃)₂, MnCl₂, Mn(ClO₄)₂, MnSO₄, MoCl₂, MoCl₄, MoCl₅, MoOCl₄, NbCl₄, NbCl₅, Nb(SO₄)₂, Ni(NO₃)₂, NiCl₂, Ni(ClO₄)₂, NiSO₄, SbCl₃, SbCl₅, Sb₂(SO₄)₃, Sb(OCH₃)₃, Sc(NO₃)₃, ScCl₃, Sc(ClO₄)₃, Sn(NO₃)₄, SnCl₂, SnCl₄, SnSO₄, Ti(NO₃)₄, TiCl₄, Ti(ClO₄)₄, Ti(SO₄)₂, TiOSO₄, Y(NO₃)₃, YCl₃, Y(ClO₄)₃, YClO, Y₂(SO₄)₃, Zr(NO₃)₄, ZrCl₄, Zr(ClO₄)₄, Zr(SO₄)₂, or a mixture of any two or more thereof.

18. The process of claim 16, wherein the electrode active material is a cathode active material having greater than 80 wt % Ni.

19. The process of claim 16, wherein the lithium metal oxide is Li₅AlO₄, Li₄TiO₄, Li₅FeO₄, LiNiO₂, Li₃CuO₃, Li₆Zr₂O₇, Li₈Nb₂O₉, Li₃NbO₄, Li₄MoO₅, Li₂MoO₄, Li₂SnO₃, Li₈SnO₆, Li₂FeO₃, LiYO₂, Li₅SbO₅, LiScO₂, Li₂TiO₃, Li₂MnO₃, LiFeO₂, Li₂CoO₃, LiNi₂O₄, Li₂NiO₃, Li₂ZrO₃, or a mixture of any two or more thereof.

20. The process of claim 16, wherein a loading level of the cathode materials on the electrode is from about 5 to about 50 mg/cm².
